(19) United States
(12) Patent Application Publication
(10) Pub. No.: US 2005/0266877 A1
(43) Pub. Date: Dec. 1, 2005

(54) Message exchange system among wireless phone bases

(76) Inventors: Kae-Jy Chou, Hsinchu Hsien (TW); Junfeng Lu, Shang-Hai City (CN); Dandan Qiu, Shang-Hai City (CN); Chee-Kong Chong, Taipei Hsien (TW)

Correspondence Address: SUPREME PATENT SERVICES, POST OFFICE BOX 2339, SARATOGA, CA, 95070, US

(21) Appl. No.: 10/856,318

(22) Filed: May 28, 2004

(51) Int. Cl. H04Q 7/20

(52) U.S. Cl. 455/555; 455/432.1

(57) ABSTRACT

Disclosed is a message exchange system among wireless phone bases, which enables a wireless communication device to roam among a plurality of wireless phone bases. The message exchange system includes a control and manipulation device and a plurality of wireless phone bases. The plurality of wireless phone bases are used to connect to the Private Automatic Branch Exchange (PABX), and transmitting the voice communication through the PABX, and in addition, sending out the control message by means of wireless communication so as to realize the roaming. The control and manipulation device includes a control and manipulation data base and adopts the pertinent processing procedures corresponding to the classification of the control message, after receiving the control message.

### BACKGROUND OF THE INVENTION

1. Field of the Invention

The present invention relates to a message exchange system, and especially to a message exchange system among the wireless phone bases.

2. The Prior Arts

First, please refer to FIG. 1. FIG. 1 is the schematic diagram for the wireless phone base of the prior art. As shown in FIG. 1, when the wireless phone base 10 of the prior art receives the incoming call from PABX (Private Automatic Branch Exchange) 16, the wireless communication device 14 within its coverage range 12 will be alerted. Under this configuration, the voice communication transmitted between the wireless communication device 14 and PABX 16 can be classified into two sections. Wherein one section is transmitted through the wireless communication between the wireless communication device 14 and the wireless phone base 10, while the other section is transmitted through the existing telephone system between the wireless phone base 10 and PABX 16. The above-mentioned wireless communication device 14 may be the Bluetooth mobile phone, the Bluetooth smart phone, the Bluetooth PDA and the Bluetooth earphone etc., which is the portable electronic device capable of wireless communication with the wireless phone base 10.

If the above-mentioned configuration is adopted as the office telephone system, then the wireless phone base 10 can be considered as the extension. Therefore, every wireless phone base 10 is assigned a unique extension number through PABX 16. As such, when receiving the incoming calls, the wireless phone base 10 will immediately alert the wireless communication device 14. Thus the telephone will not be left unanswered just because the user of that extension is not at his seat. However, if the wireless communication device 14 moves outside the coverage range 12 of the wireless phone base 10, then the wireless communication device 14 will not be able to receive the incoming call.

### SUMMARY OF THE INVENTION

Therefore, the purpose of the present invention is to provide a message exchange system among the wireless phone bases, thus establishing a roaming network among a plurality of wireless phone bases by means of wireless transmission of control messages, such that the wireless communication device is able to roam among the wireless phone bases. However, the voice communication is still transmitted through the existing telephone system.

The message exchange system among the wireless phone bases comprises a plurality of wireless phone bases and their control and manipulation device. The plurality of wireless phone bases are used to connect to PABX, and the voice communication is transmitted through the PABX, and as such it realizes the roaming by sending control messages through wireless communication. And the control and manipulation device is provided with the control and manipulation data base, and it undertakes the pertinent processing procedures corresponding to the classification of the control message, after receiving the control message.

The spirit and advantages of the present invention can be understood more thoroughly through the following detailed description together with the attached drawings.

### BRIEF DESCRIPTION OF THE DRAWINGS

The related drawings in connection with the detailed description of the present invention to be made later are described briefly as follows, in which:

FIG. 1 is a schematic view of a conventional wireless phone base; and

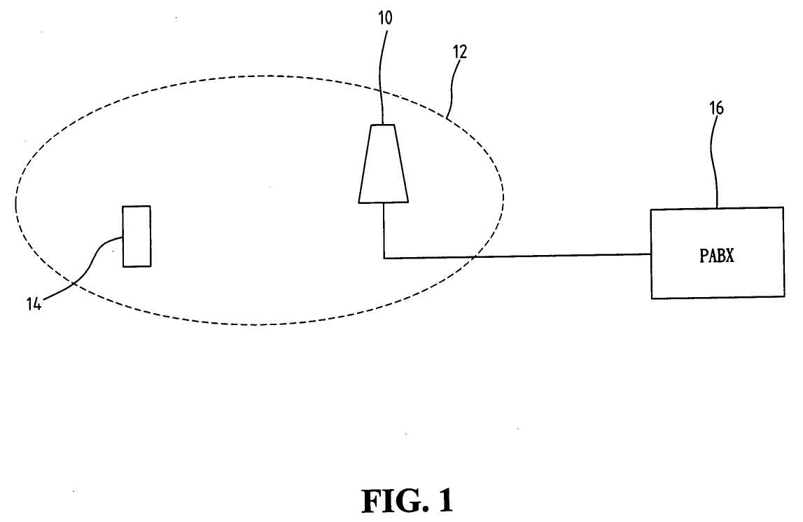

FIG. 2 is a schematic view of a roaming network structured over a plurality of wireless phone bases according the embodiment of the present invention.

### DETAILED DESCRIPTION OF THE PREFERRED EMBODIMENT

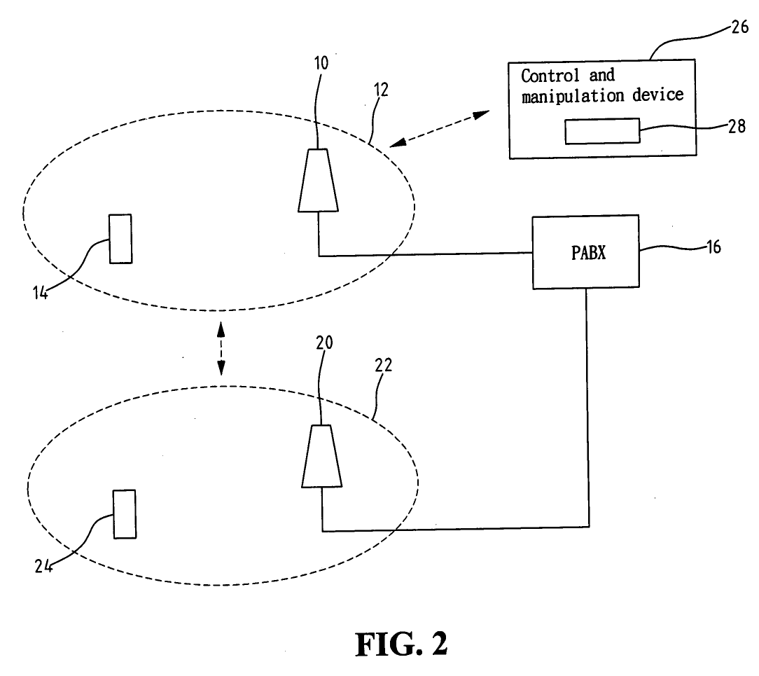

Referring to FIG. 2, which shows a roaming network structured over a plurality of wireless phone bases according to the present invention, the wireless telephone bases 10 and 20 are connected to the PABX 16 through the telephone lines, namely, the wireless telephone bases 10 and 20 are connected to the existing telephone system Therefore, the voice communication transmitted in the message exchange system between the wireless phone bases of the present invention is still transmitted through PABX 16 and the existing telephone system. As such, in the roaming network structured by the present invention, the control messages transmitted from the wireless phone bases 10 and 20 to the control and manipulation device 26 or other wireless phone bases are transmitted by means of wireless communication. After the control and manipulation device 26 receives the control messages, it adopts pertinent processing procedures corresponding to the classification of the control message through the control and manipulation data base 28 it contains. In addition, the control and manipulation device 26 may be provided in any one of the wireless telephone bases in the roaming network, or may be the standalone single unit electronic device with wireless communication capability.

Through this roaming network, the wireless communication devices 14 and 24 in the coverage ranges 12 and 22 of the wireless phone bases 10 and 20 are able to roam into the coverage ranges of each other. More specifically, when the wireless communication device 14, which is originally in the coverage range 12 of the wireless phone base 10, navigating into the coverage range 22 of the wireless phone base 20, then under the control and manipulation of the control and manipulation device 26, it will forward the incoming calls to the wireless phone base 20 via PABX 16, such that the wireless communication device 14 still be able to receive the incoming calls through the wireless phone base 20. In the following analysis of the control messages in the roaming network of the present invention, we will describe in detail the control and manipulation method provided by the control and manipulation device 26, and how this roaming network operates.

When the wireless communication device 14 enters into the coverage range 12 of the wireless phone base 10, and since the wireless phone base 10 will search the wireless communication device 14 at the predetermined intervals, and when it discovers the existence of that device 14, it will send out the control message with registration classification to the control and manipulation device 26, so as to register into the control and manipulation device 26 with the extension number of the wireless phone base 10 and device code of the wireless communication device 14, and then recording them into the control and manipulation data base 28 with the extension number corresponding to the device code. At this time, the wireless communication device 14 may be considered as being native-registered, with the wireless phone base 10 as its home base. However, if the wireless communication device 24 roams into the coverage range of the wireless phone base 10, though at this time, the wireless phone base 10 will still send the control message with its registration classification to the control and manipulation device 26, but for the wireless phone base 10 which is not its home base, the wireless communication device 24 is the visit-registered wireless communication device. Therefore, when the wireless communication device 24 roams into the coverage range of the wireless phone base 10, the records in control and manipulation data base 28 will indicate that the wireless phone base 10 is in possession of two wireless communication devices 14 and 24.

When the wireless phone base 10 receives the incoming call, the wireless phone base 10 will search and alert the wireless communication device 14 within its coverage range. However, when the wireless phone base 20 receives the incoming call, and since the wireless phone base 20 searches but can not find the existence of the wireless communication device 24 within its coverage range, and then the wireless phone base 20 will send out control message with search classification to the control and manipulation device 26, and will search out the wireless phone base visited by the visit-registered wireless communication device 24 as the wireless phone base 10 via searching through the control and manipulation data base 28. And then, the wireless phone base 20 will forward the incoming call to the wireless phone base 10 visited by the wireless communication device 24 via PABX 16, so as to alert the visit-registered wireless communication device 24. Since the technology of forwarding the incoming calls through PABX is the prior art, therefore it will not be repeated here for brevity's sake.

Summing up the above, the message exchange system provided among the wireless phone bases according to the embodiment of the present invention, structuring the roaming network by means of wirelessly transmitting the control messages to the control and manipulation device 26 among a plurality of wireless phone bases (in the above example, the wireless phone bases 10 and 20), so as to enable wireless communication devices 14 and 24 to roam in the network. However, the transmission of voice communication is still through PABX 16 and the existing telephone system of the prior art.

By way of the above detailed description of the preferred embodiment of the present invention, it is intended to give a clearer illustration of the characteristics and spirit of the present invention rather than be restrictive to the scope of the present invention with the preferred embodiment as disclosed above. On the contrary, its purpose is to include various changes and the equivalent arrangements which fall into the scope of the appended Claims.

1. A message exchange system disposed among the wireless phone bases and used to enable the wireless communication device to roam among a plurality of wireless phone bases, the message exchange system comprising:
a plurality of wireless phone bases used to connect to a Private Automatic Branch Exchange PABX), transmitting the voice communication through the said PABX, and sending out the control message by means of wireless communication so as to realize the roaming; and
a control and manipulation device, comprising a control and manipulation data base, and adopting the pertinent processing procedures corresponding to the classification of the said control message after receiving the control message.

2. The message exchange system as claimed in claim 1, wherein The extension number is assigned by the PABX to the said wireless phone base.

3. The message exchange system as claimed in claim 2, wherein when entering the coverage range of the wireless phone base, the said wireless phone base will send out the said control message with registration classification, such that the said control and manipulation device will register in the control and manipulation device with the said extension number of the said wireless phone base and the device code of the said wireless communication device; and recording them into the control and manipulation data base, with the extension number corresponding to the said device code; and if the wireless communication device corresponding to the said device code is the native-registered wireless communication device, then the said wireless phone base is its home base.

4. The message exchange system as claimed in claim 2, wherein when entering the coverage range of the wireless phone base, the said wireless phone base will send out the said control message with registration classification, such that the said control and manipulation device will register in the control and manipulation device with the said extension number of the said wireless phone base and a device code of the said wireless communication device; and recording them into the control and manipulation data base, with the extension number corresponding to the said device code; and if the wireless communication device corresponding to the said device code is the visit-registered wireless communication device, then the said wireless phone base is not its home base.

5. The message exchange system as claimed in claim 1, wherein when receiving the incoming call, the said wireless phone base will search and alert the said wireless communication device within the its coverage range.

6. The message exchange system as claimed in claim 4, wherein when receiving the incoming calls, and if the wireless phone base searches but can not find the wireless communication device within its coverage range, then the said wireless phone base will send out the said control message of search classification, and searching out the said wireless phone base visited by the said visit-registered wireless communication device via searching through the said control and manipulation data base, and forwarding the incoming call to the said visited wireless phone base through the PABX, so as to alert the said visit-registered wireless communication device.

7. The message exchange system as claimed in claim 1, wherein the control and manipulation device is provided in one of a plurality of wireless communication bases.

8. The message exchange system as claimed in claim 1, wherein the control and manipulation device is the electronic device with wireless communication capability.

9. The message exchange system as claimed in claim 1, wherein the wireless communication device is one of the following devices: the Bluetooth mobile phone, the Bluetooth smart phone, the Bluetooth PDA, and the Bluetooth earphone.
